(19) United States
(12) Patent Application Publication
(10) Pub. No.: US 2025/0300381 A1
(43) Pub. Date: Sep. 25, 2025

(54) Plug-and-socket connection, in particular a data and power plug-and-socket connection and method of manufacturing a plug-and-socket connector

(71) Applicant: Weidmüller Interface GmbH & Co. KG, Detmold (DE)

(72) Inventors: Benedikt STEUBE, Löhne (DE); Stefan APORIUS, Detmold (DE); Roman HENZE, Horn-Bad Meinberg (DE); Tobias GÜNTER, Detmold (DE); Matthias FILKER, Warburg (DE); Patrick LAUERMANN, Bad Salzuflen (DE); Thomas WIELSCH, Detmold (DE); Sascha WALTER, Augustdorf (DE)

(21) Appl. No.: 19/075,285

(22) Filed: Mar. 10, 2025

(30) Foreign Application Priority Data
Mar. 20, 2024 (DE) 102024107929.0

(51) Int. Cl. H01R 13/03; C25D 3/56; C25D 5/34; C25D 5/50; C25D 7/00; H01R 43/16

(52) U.S. Cl. CPC H01R 13/03; C25D 3/562; C25D 5/34; C25D 5/50; C25D 7/00; H01R 43/16

(57) ABSTRACT

A plug-and-socket connection, preferably a data and power plug-and-socket connection, and more particularly preferably an SPE-plug-and-socket connection, comprises at least two plug-and-socket connection components being a mating plug-and-socket connector and a plug-and-socket connector. the components each have at least one contacting member, wherein one of the contacting members electrically contacts the other contacting member in a contacting region by connecting the mating plug-and-socket connector with the plug-and-socket connector. A metal base body of the contacting member is arranged in the contacting region and includes a single-layer or multi-layer nickel/phosphorus alloy. There is also a method for producing a plug-and-socket connector of the plug-and-socket connection.

### BACKGROUND

The present invention relates to a plug-and-socket connection, preferably a data and power plug-and-socket connection and method of manufacturing a plug-and-socket connector of this plug-and-socket connection.

In the field of plug-and-socket connections, in particular data and power plug-and-socket connections, contact partners for contacting two connection partners have contact regions containing precious metals. These are typically constructed as a multi-layer system with a comparatively hard base coating and a gold layer disposed on top.

While the base coating provides mechanical protection against damage to the coating and the base material during several mating processes, the soft gold layer serves as a lubrication partner but also as a contacting partner, which ensures good contacting with low contact transition resistances between the two connection partners. In addition, as a precious metal, gold does not tend to corrode in industrial atmospheres, and can therefore keep the contact transition resistance stable.

A multi-layer system with at least two layers was previously considered essential for precious metal-containing contacting regions due to different functionalities.

Particularly with data plug-and-socket connectors, i.e. in the high-frequency range, there are critical limit values with regard to transition resistance requirements, which should not be exceeded or fallen short of. A gold layer for ensuring data transmission with a standard-compliant transmission quality, in particular with regard to the contact transition resistance, has so far been regarded as mandatory.

Relevant documents in the context of the present invention are DE 10 2012 109 057 B3, DE 10 2013 109 400 A1, DE 10 2014 105 823 A1, DE 10 2015 118 779 A1 and DE 10 2016 110 377 A1.

Based on this preliminary consideration, there is thus a need for a good compromise between a sufficient transmission of signals (data) and/or power and simple cost-optimized production.

### SUMMARY OF THE DISCLOSURE

Accordingly, it is an object of the present disclosure to provide a plug-and-socket connection which can transmit data and/or power and a method for its manufacture.

The plug-and-socket connection is configured as an electrical plug-and-socket connection with electrical contacting of two plug-and-socket connection components. The plug-and-socket connection can be configured as a data and/or power plug-and-socket connection. Preferably, the plug-and-socket connection is configured both as a data plug-and-socket connection and as a power plug-and-socket connection. The plug-and-socket connection comprises at least two plug-and-socket connection components in the form of a mating plug-and-socket connector and a plug-and-socket connector.

Each of the two plug-and-socket connection components has a contacting member, whereby one of the two contacting members makes electrical contact with the other contacting member in a contacting region by plugging the plug-and-socket connector into the mating plug-and-socket connector.

A metal base body of the contacting member in the contacting region includes a a single-layer or multi-layer nickel/phosphorus alloy coating. The Ni—P-layer can be applied in several electroplating baths in several operations, so that a multi-layer Ni—P-layer system can be formed.

That is, at least the contacting member described above has only a single nickel/phosphorus alloy layer. Due to its increased hardness, the alloy layer protects the base body from mechanical damage and abrasion. Further layers or coatings are not provided in the single-layer design.

A single-layer coating overcomes the drawback of a contacting member always requiring a further pure metal layer, primarily gold, to increase conductivity and maintain corrosion resistance. In such instances, the gold layer is separated/spaced from the contacting member base material by a nickel barrier layer. Extensive tests have surprisingly shown that contacting members provided exclusively with the nickel/phosphorus alloy layer also have sufficient contacting properties, in particular for a single-pair Ethernet (SPE) plug-and-socket connection.

Without the additional gold layer, production is more material-efficient and resource-efficient with less effort owing to omitting a coating step.

Conversely, the nickel content acts as a barrier layer in gold plating. Without this barrier layer, the gold diffuses into the base material (e.g. brass) and is therefore less effective.

In one embodiment, the metal base body is made of copper or a copper alloy. Copper and copper alloys form a good bond with a nickel/phosphorus alloy. The changing temperature stresses that occur during use do not cause the coating to peel off at material transitions.

An intermediate layer can also be applied between the base body and the coating in a multi-layer design. Such layers can be made of copper, nickel and/or iron and can be designed as adhesion promoters to improve electrochemical compatibility, which in turn improves the bonding energies and/or increases the phase growth.

Forming pure nickel intermediate layers can be improved as a result, and an adhesion promoter is suitable for improving adhesion when applied to a copper flash.

For optimal signal transmission and to enable sufficiently good contacting with simultaneous mechanical protection, it is advantageous for the average layer thickness of the single-layer to be between 1.5-5 μm, and ideally between 2.5-4 μm.

The proportion of phosphorus in the alloy is preferably greater than 9 wt %. The proportion of phosphorus enables the formation and setting of the extent of amorphous proportions in the semi-crystalline coating. These increase the corrosion stability compared to pure nickel or nickel with lower phosphorus proportions. At the same time, the phosphorus proportions reduce the conductivity of the coating and/or cause an increase in the brittleness of the coating. Therefore, the proportion of phosphorus is preferably less than 20 wt %, and more preferably less than 15 wt %.

Ideally, the alloy should have only a few defects the inclusion of which can be controlled via the speed of deposition. The coating preferably comprises at least 99 wt % exclusively nickel and phosphorus and 1 wt % or less of other ingredients, such as silicon compounds and the like.

The plug-and-socket connection can have a plug-and-socket connector with contacting members of the single-layer and the second plug-and-socket connector, i.e. the contacting member of the corresponding plug-and-socket connector or the corresponding mating plug-and-socket connector, can have a two-layer or multi-layer coating.

The other of the two corresponding contacting members of the two plug-and-socket connectors can also have a two-layer configuration in the contacting region. A first layer of a nickel/phosphorus alloy and a second layer of gold with a layer thickness of less than 0.2 μm, preferably between 0.1-0.15 μm, are recommended. Typical layer thicknesses in the contacting region tend to be around 0.8 μm. Due to sufficient contacting, layer thickness can be omitted at this point.

However, it is also possible for both plug-and-socket connectors to have the aforementioned single- or multi-layer layers.

It is further an object of the present disclosure to provide a method for producing a plug-and-socket connector of the aforementioned plug-and-socket connection according to the invention, wherein the method includes at least the steps of surface-cleaning and molding the metal base body of the contacting member by stamping and/or bending, dipping the base body into an electrolyte bath comprising nickel ions and a phosphorus species, and setting the current density as a function of a specified target value of a proportion of phosphorus in the alloy. This can be done by using empirical values which allow a defined phosphorus proportion in the alloy at a certain current density and energization time and at a known concentration of phosphorus species.

A further step includes drying and/or heat-treating, wherein the heat-treating takes place at temperatures of greater than 200° C., and mounting the contacting member in a housing, with provision of the plug-and-socket connector. Heat-treating significantly increases the hardness of the coating.

Such mounting is known in principle. The contacting member can be inserted into a contact carrier and/or overmolded with potting material. Optionally, the contact carrier can also be equipped with a shielding member, which may be equipped with external insulation and, optionally, latching means. The shape and design of corresponding plug-and-socket connectors and mating plug-and-socket connectors, in particular SPE plug-and-socket connectors, is fundamentally known and can be realized through mounting.

in one embodiment of the method, surface-cleaning can take place in an alkaline degreasing bath and the alkali film can subsequently be removed by a pickling process. Thus, several method steps are efficiently combined.

The electrolyte bath preferably has a pH value of less than 3.0, and more preferably a pH value of 2.5+/−0.2. In this acidic environment, good process control is possible for the galvanic coating.

Phosphorus acid and/or hypophosphorous acid and/or salts thereof can be employed advantageously as phosphorus species. This reduces the use of other acids to set the pH value.

The preferred concentration of phosphorous acid and/or a phosphonate in the electrolyte solution is greater than 20 g/l, and preferably between 20-35 g/l. This ensures optimal coating conditions.

An aqueous solution of nickel sulphate and/or nickel sulfamate and/or nickel chloride is employed in the electrolyte solution as the nickel species.

Preferably, the electrolyte solution can have a concentration of nickel in the electrolyte of 80-120 g/l.

To set the process conditions, in particular the pH value, the electrolyte solution can moreover have boric acid and/or sulfuric acid.

Nickel anodes can preferably be employed as anodes in the galvanic coating.

Furthermore, a preferred target value for a current density is between 5 to 25 A/dm², and more preferably between 18 to 22 A/dm². This represents a good compromise with regard to good production efficiency and a low number of defects in the coating.

Setting the current density preferably takes place at temperatures of greater than 50° C., preferably between 55-80° C. This increases the deposition speed and thus the production efficiency.

For more extensive hardening of the coating, heat-treating can take place at temperatures between 200-500° C.

Before or after the step of galvanic coating, there can be a chemical preparation and/or a chemical post-treatment of the metal surface of the contacting member, wherein each step of the chemical preparation and/or post-treatment comprises rinsing the correspondingly prepared or post-treated surface with deionized water in order to avoid the inclusion of foreign ions in the coating.

### BRIEF DESCRIPTION OF THE DRAWINGS

Hereafter, a data and power plug-and-socket connection according to the invention is described in greater detail using a Single-Pair Ethernet plug-and-socket connector, also known as an SPE connector, with the aid of the following figures. In the drawings:

FIG. 1 is a side view of a first plug-and-socket connection according to the invention, as a variant of an SPE plug;

FIG. 2 is a plan view of the plug-and-socket connection from FIG. 1;

FIG. 3 is a side view of the metal contacting members of both contacting members of the plug-and-socket connection;

FIG. 4 is a plan view of the metal contacting members from FIG. 3;

FIG. 5 is a method diagram of a manufacturing method according to the invention; and

FIG. 6. is a side sectional view of a variant of a plug connection according to the invention, here in the form of a circular plug connector.

### DETAILED DESCRIPTION

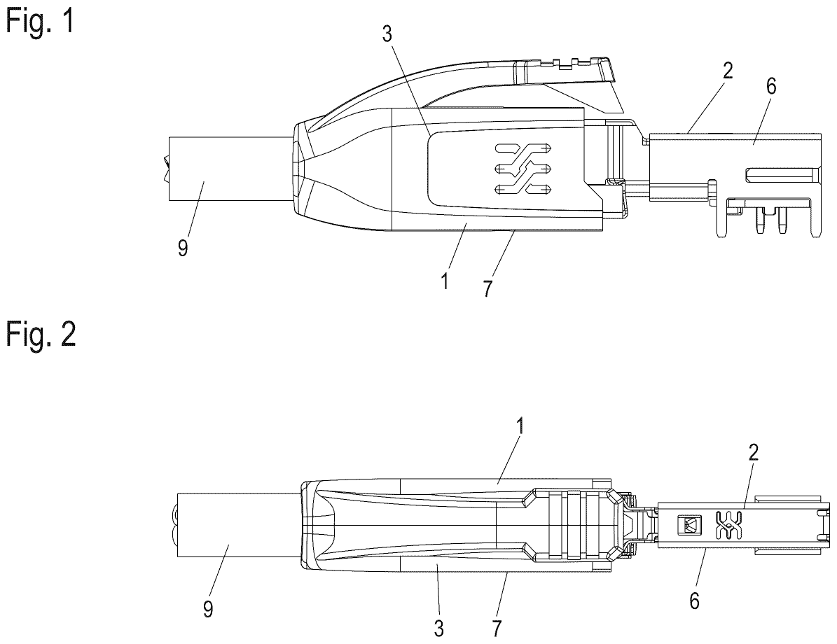

FIGS. 1-4 show a plug-and-socket connection 1 including a data and power plug-and-socket connection with an SPE-mating plug-and-socket connector 2 and a corresponding SPE plug-and-socket connector 3 as a data and power connector.

Both the SPE-mating plug-and-socket connector 2 and the SPE plug-and-socket connector 3 have metal contacting members 4, 5, 4′, 5′, which are each surrounded by a box-shaped shielding member 6, 7. At least the SPE plug-and-socket connector 3 is overmolded.

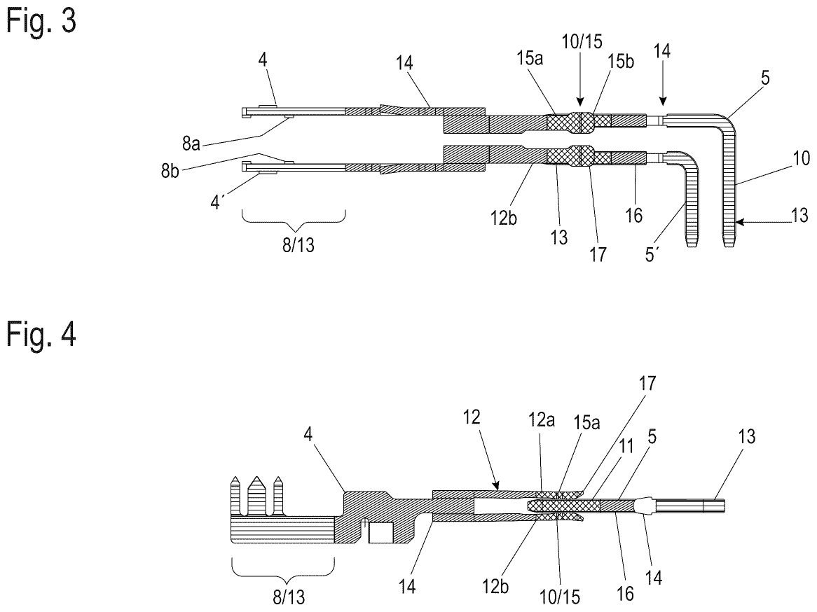

The contacting members 4, 5, 4′, 5′ are each preferably formed in one piece. In FIGS. 3 and 4, two contacting members of the mating plug-and-socket connector 2 and/or of the plug-and-socket connector 3 are aligned parallel to each other. Two contacting members 4 of an SPE plug member, in this case the SPE mating plug-and-socket connector 3, have a contact region 8 for contacting, preferably electrically contacting, a wire end section of a two-wire cable 9. This region of the plug-and-socket connector is also referred to as the connector terminal region 13. Furthermore, the plug-and-socket connector has a transition region 14, i.e. a center section, and a contact region or contacting region 15. The individual wires of the cable 9 are linked to the contacting members 4, 4′ via piercing contacts (IPC). Insulation-displacement connectors (IDC) or other contacting options are also possible. The cable 9 is thus linked to the plug-and-socket connection.

The plug-and-socket connectors can also be formed in various other ways as an alternative to the depicted design variant.

An essential element of the present invention is the contacting region 15, at which the contact 10 of the two plug-and-socket connectors takes place (i.e. of the contact and of the mating contact, or of the mating plug-and-socket connector 2 and of the plug-and-socket connector 3).

As shown in FIG. 4, the mating plug-and-socket connector 2 has a contact pin 11, which is plugged into a contact tulip 12 of the plug-and-socket connector 3. The contact pin 11 is clamped in two opposing spring contacts 12 by two spring limbs 12a and 12b. The spring limbs 12a and 12b are also part of the contacting region 15a of the plug-and-socket connector 3, while the region on which the spring limbs 12a and 12b rest on the contact pin 11 is part of the contacting region 15b of the contact pin.

However, the contact regions 8a and 8b are not limited to the terminal configuration of the pin-shaped and two opposing spring contacts of the contacting members 4 and 5. It is therefore possible to arrange corresponding contact regions, which do not have a pin or tulip shape, on other contacting members.

The contacting regions 15a and 15b of the contact members 4 and/or 5 have a metal base body 16. This metal base body can preferably consist of a copper alloy.

A conductive abrasion protection layer is applied to the metal base body as a coating 17. This is configured as a nickel/phosphorus alloy layer, preferably with a phosphorus content of at least 9 wt %. It is particularly preferred to have only two alloy components, phosphorus and nickel, whereby the proportion of nickel predominates over the proportion of phosphorus. The proportion of phosphorus in the alloy is preferably less than 20 wt %, and more so preferably less than 15 wt %.

The nickel-phosphorus layer has a mean layer thickness between 1.5-5 μm, ideally between 2.5-4 μm. The latter ideal range of 2.5-4 μm represents a particularly good compromise between reliable abrasion protection and the quality of the signal transmission with regard to the transition resistances between the contacting members involved.

The nickel-phosphorus layer preferably has a completely amorphous structure or at least a partially amorphous structure with a predominantly amorphous volume proportion in the structure.

In contrast to pure nickel, a nickel-phosphate layer does not form any ceramic nickel oxide components. As a result, the attenuation when transmitting signals in the high-frequency range, in particular in the range of 600 MHz to 1 GHz, is comparatively low throughout the layer.

Surprisingly, it has been shown that a gold layer is not necessary to improve the signal transmission in the contacting region 15a or 15b of a contacting member due to the sufficient signal transmission. Rather, a single-layer coating of the aforementioned nickel/phosphorus alloy on the metal base body of the contacting member provides sufficient signal transmission.

Testing, evaluation and classification of a plug-and-socket connector using a measuring device can be carried out using a test adapter, one of which is described, in the IEC 63171 standard, which also contains the standardized specifications for plug-and-socket connectors for the transmission of an Ethernet protocol via two wires. In addition to the mechanical dimensions of the mating faces of the plug-and-socket connectors, this standard also lists the specifications regarding transmission quality. These specifications concern, for example, the values for insertion loss and return loss, transfer impedance, coupling attenuation and other parameters. The transmission quality of an SPE plug-and-socket connection can therefore be determined in accordance with this standard and compared with other plug-and-socket connections.

It is possible that a contacting member of one of the plug-and-socket connectors has a gold layer over a nickel barrier layer as a top layer, while the contacting member of the other plug-and-socket connector has the aforementioned single layer. If the contacting member of one of the plug-and-socket connectors has a gold layer, its average layer thickness is preferably between 0.1 and 0.15 μm.

As shown in FIGS. 3 and 4, the single-layer coating 17 is only arranged in the contacting region 15, whereby the contacting region is not exclusively defined by the area that is actually in contact with the contacting region of the complementary contacting member. It also extends beyond the contacting member 10 over a small area. Outside this contacting region 15, the base body 16 in the transition region 14, i.e. between the contacting region 15 and the connector terminal region 13, is preferably free of coating.

The layer thicknesses of the single-layer or multi-layer metal coating can be determined using a standard eddy-current thickness gauge. Commercially available measuring devices measure in the range of a few nanometers to the millimeter range.

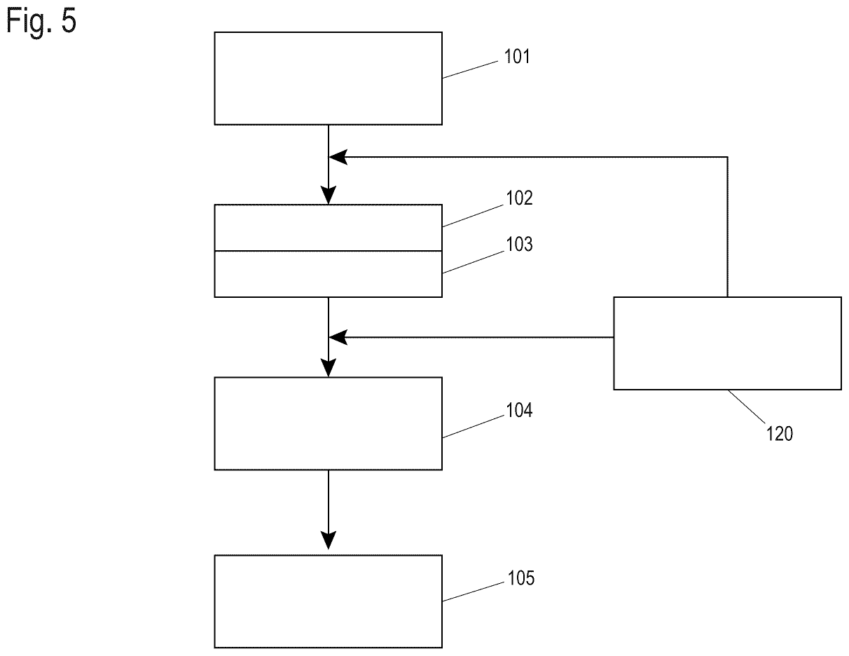

The coating of the nickel/phosphorus alloy layer can be applied to the metal base body by a galvanic coating process. This is explained with reference to FIG. 5.

The first step 101 comprises surface-cleaning and molding by punching and/or bending the workpiece into the shape of the contact member. The sequence of surface-cleaning and molding is as desired. Surface-cleaning the base body or the sheet metal prior to molding the base body can be via a surfactant-containing alkaline cleaning bath. The cleaning bath can preferably be configured as a pickling bath so that tempering colors and oxides formed on the surface are removed at the same time. Alternatively, degreasing and pickling to remove tempering colors or oxide layers can be carried out separately.

In a second step 102, the base body is dipped into an electrolyte bath.

The electrolyte bath has a pH value of preferably less than 2.0, and more preferably the pH value is 1.0+/−0.2.

Suitable phosphorus species for the deposition of the phosphorus-containing alloy are phosphorous acid, hypophosphorous acid or salts thereof. Phosphorous acid is preferred, as it has been shown that phosphinates produce a lower layer quality.

The preferred concentration of phosphorous acid or a phosphonate in the electrolyte solution is greater than 5 g/l, preferably between 15-25 g/l.

Nickel sulphate or nickel chloride dissolved in water can be employed as the electrolyte salt. The weight can vary depending on the proportion of water crystallization in the electrolyte salt. A preferred concentration of nickel in the electrolyte is 45-65 g/l.

Furthermore, boric acid, e.g. between 20-40 g/l, can be used to optimize the process. Nickel anodes can be employed as anodes in the galvanic coating.

In a third step 103, the current density is set as a function of the concentration of dissolved nickel sulphate and/or dissolved phosphorus species in the electrolyte solution. A preferred current density is between 0.7 and 5.0 A/dm², and more preferably between 0.8 and 4.0 A/dm².

In the third step, the galvanic coating is preferably carried out at temperatures of greater than 50° C., and more preferably between 55-80° C.

The pH value may change due to the incorporation of phosphorus in the alloy and the associated consumption of phosphorous acid. The pH value can be set during the third step 103 by adding sulfuric acid.

Finally, the fourth step includes drying and/or heat-treating at greater than 200° C., preferably between 300-500° C. Heat-treating can significantly improve the hardness properties of the nickel/phosphorus alloy layer.

Steps 102 and 103 form two sub-steps of an electrodeposition.

Preferably, after each step of the preparation and/or before each post-treatment of the electrodeposition step, the metal surface, be it of the base body to be coated or of the electroplated layer, is preferably rinsed 120 with deionized water.

Finally, the contacting member is mounted by positioning it in the shielding member 6 or 7 and providing the plug-and-socket connector in a known manner. The contacting member can be arranged in a contact carrier, which in turn is surrounded by the shielding member 6 or 7.

The variants of a plug-and-socket connection and an electrodeposition method described above are only part of an embodiment example. Based on the example shown, a skilled person in the art can make numerous other modifications which also fall within the subject-matter of the invention.

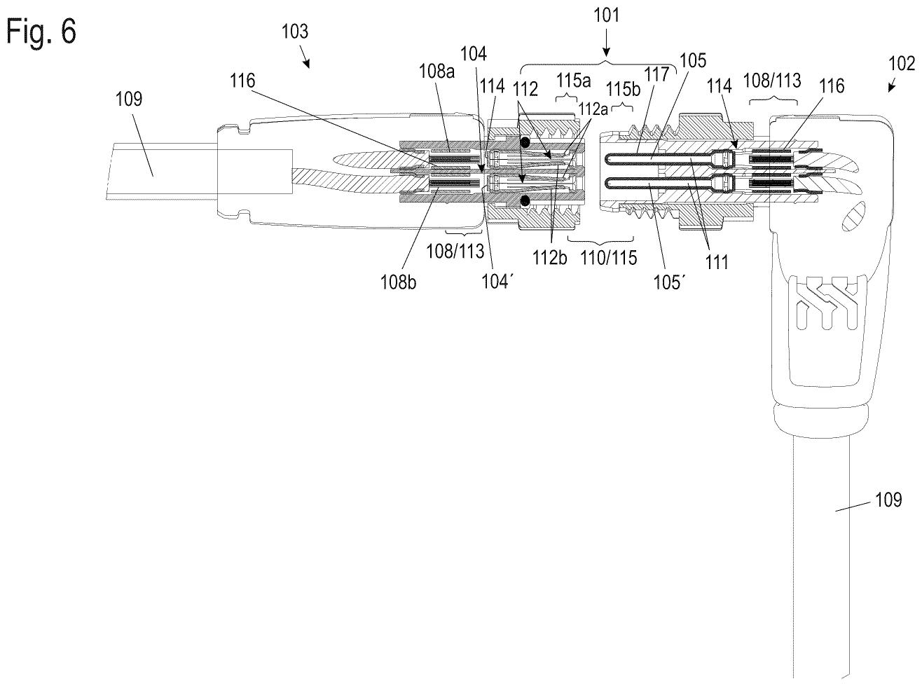

FIG. 6 shows a further embodiment variant of an SPE connector 101 with a connector 103 and a mating connector 102, here in the form of a circular connector.

Contacting elements 104, 104′, 105, 105′ are provided for the two plug connection components.

Just like in the variant of FIGS. 1-4, a contact area 108, 108a, 108b is provided. The plug connection components each have a cable 109 at the end. In the plugged state, there is contact 110 via a contact pin 111 and a spring contact 112 comprising two spring legs 112a, 112b. A conductor connection area is also provided. The plug connector 103 has a transition area 114, i.e. a middle piece, and a contact or contacting area 115. The contacting areas 115b of the contact elements 105 have a metallic base body 116 analogous to FIGS. 1-4. This metallic base body preferably consists of a copper alloy and has a coating 117 as abrasion protection.

Specifically, FIG. 6 is an unshielded 4-pin M8 circular connector, in which only 2 poles (contacts) can be seen in the view. The plug connector 103 is equipped with a union nut which is screwed onto a mating thread of the mating plug connector 102. The contacts are located in a contact carrier, with the area between the end of the contact carrier and the cable end being a plastic housing. The mating connector 102 is an angled version and includes the coating 117.

What is claimed is:

1. A plug-and-socket connection, comprising at least two plug-and-socket connection components being a mating plug-and-socket connector and a plug-and-socket connector, the two plug-and-socket connection components each having at least one contacting member, the plug-and-socket connector being connected with the mating plug-and-socket connector via one of the at least one contacting members electrically contacting the other at least one contacting member in a contacting region, a metal base body of the contacting member arranged in the contacting region and having one of a single-layer and multi-layer coating including nickel and phosphorus alloy.

2. The plug-and-socket connection according to claim 1, wherein the metal base body is made of one of a copper and a copper alloy.

3. The plug-and-socket connection according to claim 1, wherein an intermediate layer is applied between the base body and the coating.

4. The plug-and-socket connection according to claim 1, wherein a mean layer thickness of the single-layer or multi-layer coating is between 1.5 and 5 μm.

5. The plug-and-socket connection according to claim 1, wherein the phosphorus proportion in the nickel and phosphorus alloy coating is greater than 9 wt % and less than 20 wt %.

6. The plug-and-socket connection according to claim 1, wherein the nickel and phosphorus alloy comprises up to 99 wt % nickel and phosphorus.

7. The plug-and-socket connection according to claim 1, wherein a further contacting member is arranged in the contacting region, the further contacting member having a two-layer coating, a first layer including a nickel and phosphorus alloy and a second layer including gold with a thickness of less than 0.2 μm.

8. A method for producing a plug-and-socket connector according to claim 1 comprising the steps of:
a. surface-cleaning and one of stamping, bending and both stamping and bending the metal base body of the contacting member to mold the body;
b. dipping the base body into an electrolyte solution comprising nickel ions and a phosphorus species;
c. setting the current density as a function of a proportion of phosphorus in the alloy coating;
d. one of drying, heat-treating, and both drying and heat-treating the body, wherein heat-treating takes place at temperatures of greater than 200° C.; and
e. mounting the contacting member in a housing and providing the plug-and-socket connector.

9. The method according to claim 8, wherein surface-cleaning takes place in an alkaline degreasing bath, the alkali film being subsequently removed via a pickling process.

10. The method according to claim 8, wherein the electrolyte bath has a pH value of less than 3.0.

11. The method according to claim 8, wherein the phosphorous species includes at least one of phosphorous acid, hypophosphorous acid, and salts thereof.

12. The method according to claim 11, wherein the electrolyte solution includes a concentration of one of phosphorous acid, phosphonate, and both phosphorous acid and phosphonate that is greater than 20 g/l.

13. The method according to claim 8, wherein the electrolyte solution comprises an aqueous solution including one of nickel sulphate, nickel sulfamate, nickel chloride, and a combination of two or all three thereof.

14. The method according to claim 8, wherein the electrolyte solution includes a nickel concentration of 80-120 g/l.

15. The method according to claim 8, wherein the electrolyte solution further comprises one of boric acid, sulfuric acid, or both boric acid and sulfuric acid for adjusting the process conditions, in particular the pH value.

16. The method according to claim 8, wherein nickel anodes are employed as anodes in the coating process.

17. The method according to claim 8, wherein a current density is between 5 to 25 A/dm².

18. The method according to claim 17, wherein the current density is set at temperatures of greater than 50° C.

19. The method according to claim 8, wherein heat-treating takes place at temperatures between 200-500° C.

20. The method according to claim 8, wherein before the dipping steps or after the setting step the method further comprises one of a chemical preparation of the metal surface, a chemical post-treatment of the metal surface, and a chemical preparation and post-treatment of the metal surface, chemical preparation and post-treatment each including rinsing with deionized water.
